(19) United States
(12) Patent Application Publication
(10) Pub. No.: US 2008/0032178 A1
(43) Pub. Date: Feb. 7, 2008

(54) Solid oxide fuel cell device with an elongated seal geometry

(76) Inventors: Phong Diep, Newfield, NY (US); Scott Christopher Pollard, Big Flats, NY (US); Sujanto Widjaja, Corning, NY (US)

Correspondence Address: CORNING INCORPORATED, SP-TI-3-1, CORNING, NY, 14831, US

(21) Appl. No.: 11/498,225

(22) Filed: Aug. 2, 2006

(51) Int. Cl. H01M 2/08; H01M 8/12

(52) U.S. Cl. 429/35; 429/30; 429/33

(57) ABSTRACT

A solid oxide fuel cell device comprises: an electrolyte sheet; at least one electrode pair sandwiching the electrolyte sheet; wherein the sealed area of said electrolyte sheet is elongated, has arcuate geometry and has a length to width aspect ratio of more than 1.0.

### BACKGROUND OF THE INVENTION

1. Field of the Invention

The present invention relates generally to fuel cell devices and more particularly to SOFC devices that utilize elongated seal geometry to seal thin zirconia based electrolyte sheets to their support so as to minimize device failure due to thermal mechanical stresses.

2. Technical Background

The use of solid oxide fuel cells has been the subject of considerable amount of research in recent years. The typical components of a solid oxide fuel cell (SOFC) comprise a negatively-charged oxygen-ion conducting electrolyte sandwiched between two electrodes. Electrical current is generated in such cells by oxidation, at the anode, of a fuel material, for example hydrogen, which reacts with oxygen ions conducted through the electrolyte. Oxygen ions are formed by reduction of molecular oxygen at the cathode.

U.S. Pat. No. 5,273,837 describes the use of such compositions to form thermal shock resistant solid oxide fuel cells. US Patent Publication US2002/0102450 describes solid electrolyte fuel cells which include an improved electrode-electrolyte structure. This structure comprises a solid electrolyte sheet incorporating a plurality of positive and negative electrodes, bonded to opposite sides of a thin flexible inorganic electrolyte sheet. One example illustrates that the electrodes do not form continuous layers on electrolyte sheets, but instead define multiple discrete regions or bands. These regions are electronically connected, by means of electrical conductors in contact therewith that extend through vias in electrolyte sheet. The vias are filled with electronically conductive materials (via interconnects).

U.S. Pat. No. 5,085,455 discloses thin, smooth inorganic sintered sheets. The disclosed sintered sheets have strength and flexibility to permit bending without fracturing; as well as excellent stability over a wide range of temperatures. Some of the disclosed compositions, such as yttria stabilized zirconia YSZ (Y₂O₃—ZrO₂) would be useful as electrolytes for fuel cells. It is known that at sufficient temperatures (e.g., about 725° C. and above), zirconia electrolytes exhibit good ionic conductance and very low electronic conductance. U.S. Pat. No. 5,273,837 describes the use of such compositions to form thermal shock resistant solid oxide fuel cells.

However, due to large operating temperatures and rapid temperature cycling the SOFC devices are subjected to thermal-mechanical deformation and stress. These stresses impact operational reliability of SOFC devices and their lifetime. The electrolyte sheets are sealed to their support structures in order to keep fuel and oxidant gasses separate. In some cases, the thermal-mechanical deformation and stress may be concentrated at the interface at the interface between the fuel cell device and the seal, resulting in the failure of the SOFC device, and/or the seal. When a thin and flexible ceramic sheet is utilized as electrolyte in SOFC applications, there is a likelihood of premature failure of the electrolyte. The device/seal/frame interaction due to temperature gradients (and thermal cycling), mismatch of expansion, mismatch of rigidity, and differential gas pressure may lead to stress increase at the seal, and at the unsupported region of the electrolyte sheet adjacent to seal. Additionally, a large and thin electrolyte sheet may fail due to fracturing of electrolyte sheet wrinkles, where fracturing is induced by thermo-mechanical stresses.

US Patent application US2006/0003213 also describes the problem of stress related cracking of the SOFC device electrolyte sheet. It discloses a patterned electrolyte sheet, with the patterns that are designed to compensate for the environmentally induced strain, providing an increased resistance to failure of the device. However, alternative and/or additional thermal stress minimization approaches may also serve as mitigation schemes to overcome thermal-mechanical failures of fuel cell devices.

### SUMMARY OF THE INVENTION

According to one aspect of the invention a solid oxide fuel cell device comprises:
(a) electrolyte sheet;
(b) at least one electrode pair sandwiching the electrolyte sheet;
wherein said electrolyte sheet has a sealed area with length to width aspect ratio of more than 1.0. Preferably, the electrolyte sheet is at least 250 cm² and the sealed area of the electrolyte sheet has a length to width ratio of at least 1.1 or more, more preferably at least 1.3 and even more preferably at least 2, and most preferably larger than 3.5. Preferably the electrolyte sheet is sealed to its support or frame with a seal having a thickness (height) of at least 50 μm, a width of at least 100 μm, and a perimeter with rounded corners. Preferably the radius of the rounded seal corners is at least 3 mm, more preferably at least 5 mm. Preferably the seal height h is smaller than its width w.

According to one embodiment of the present invention solid oxide fuel cell device comprises:
(a) a thin flexible zirconia based electrolyte sheet supporting at least 10 electrode cathode/anode pairs;
(b) a frame supporting said electrolyte sheet; and
(c) an elongated seal adjacent to the perimeter of said electrolyte sheet and situated between said electrolyte sheet and said frame, said seal sealing said electrolyte sheet to said frame. Preferably the electrolyte sheet thickness is less than 100 μm, and more preferably 3 μm to 30 μm. Preferably the seal length to width ratio across the perimeter of the sealed are is at least 1.3, and more preferably larger than 2, and even more preferably larger than 3. Preferably the seal has a perimeter with rounded or arcuate geometry. Preferably, the radius of the rounded area is at least 5 mm, and more preferably at least 5 cm.

One advantage of the solid oxide fuel cell (SOFC) device of the present invention utilizing an elongated and smooth (arcuate) seal geometry is that the resultant SOFC device has an improved performance and reliability due to (i) reduction of stress at the electrolyte sheet/seal interface, and (ii) reduction -in number and-amplitude of electrolyte sheet wrinkles at or near the seal area. According to the embodiment of the present invention the sealed area of the electrolyte sheet has an aspect ratio between 1.3:1 and 20:1, preferably between 1.5:1 and 10, and even more preferably between 2:1 and 7. Preferably the sealed area of the electrolyte sheet is at least 250 cm² and more preferably at least 300 cm².

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present exemplary embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operations of the invention.

### BRIEF DESCRIPTION OF THE DRAWINGS

FIG. 1A is a schematic top view of an exemplary fuel cell device;

FIG. 1B is a schematic cross-sectional view of the fuel cell device of FIG. 1A;

FIG. 2A is a schematic top view of the first embodiment of the present invention;

FIG. 2B is a partial cross-sectional view in the vicinity of the sealed area if the device shown in FIG. 2A;

FIG. 3 is a schematic top view of the second embodiment of the present invention;

FIG. 4 is a schematic top view of the third embodiment of the present invention;

FIG. 5A is a graph of electrolyte sheet deflection as a function of aspect ratio sealed area of the electrolyte sheet;

FIG. 5B is a graph showing the maximum principal stress as a function of aspect ratio of the sealed area of the electrolyte sheet;

FIGS. 6A-6C are schematic illustrations of exemplary oval, elliptical or other elongated geometries for the sealed area of the electrolyte sheet; and

FIG. 7 is a graph of device packing density vs. the aspect ratio of the sealed area of the electrolyte sheets.

### DETAILED DESCRIPTION OF THE PREFERRED EMBODIMENTS

Reference will now be made in detail to the present exemplary embodiments of the invention, which are illustrated in the accompanying drawings. Whenever possible, the same reference numerals will be used throughout the drawings to refer to the same or like parts.

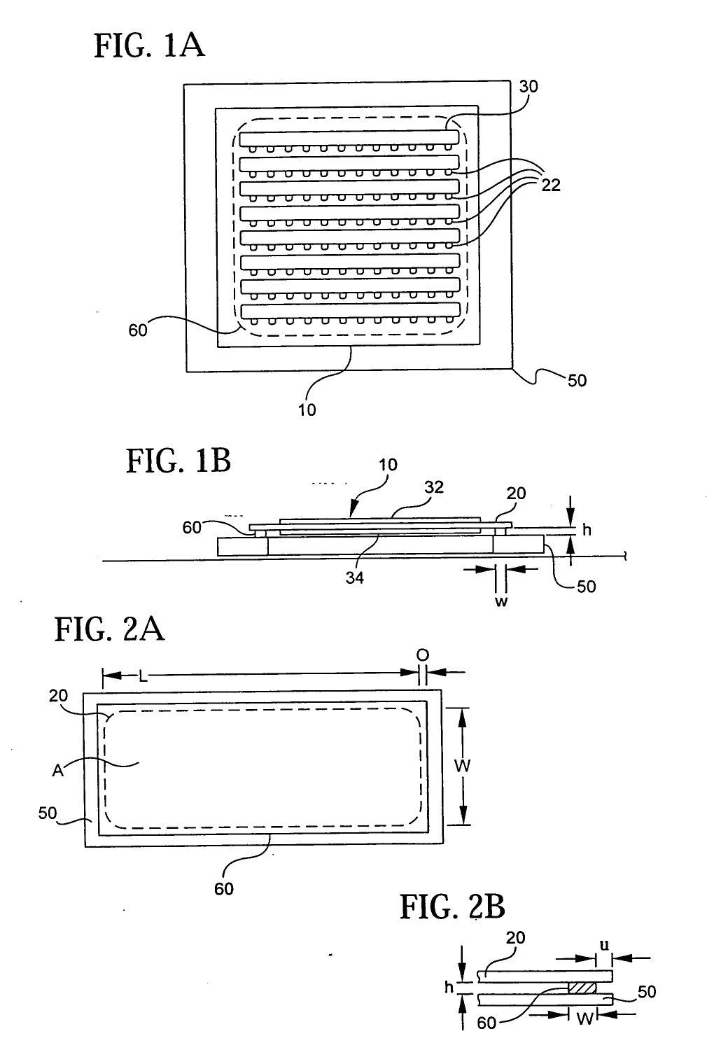

An exemplary solid oxide fuel cell device of is shown in FIG. 1, and is designated generally throughout by the reference numeral 10. The solid oxide fuel cell device 10 comprises: (a) an electrolyte 20; (b) at least one pair electrodes 30 situated on the electrolyte; (c) via connectors 22 providing electrical connections between the electrodes of adjacent cells. The device 10 is supported and housed by a support component, such as the frame 50 situated in close proximity to the electrolyte 20. The electrolyte 20 may be zirconia based sheet, may be based on following compositions: Bismuth (Bi₂O₃)—, Ceria (CeO₂)— and tantala (Ta₂O₅)— and the LSGM—(Lanthanum Strontium Gallium Magnesiun Oxide). In this example the electrolyte sheet 20 is sealed to the frame via the seal 60. During start-up/shut-down steps and the operation of fuel cell system, the thermal-mechanical response of the fuel cell device 10 and the seal 60 is likely to cause cracking of the seal and/or electrolyte at or adjacent the seal's edges, if one or more of the following conditions is present: (i) the electrolyte 20 and the seal 60 have a square cross-section, as shown in FIG. 1, and/or (ii) the area of the electrolyte sheet 20 is relatively large (for example, larger than 250 or 300 cm²), and/ or (iii) the electrolyte sheet 20 is likely to have large deflections. The larger the area of the electrolyte, the thinner and more flexible is the electrolyte sheet, the greater is the electrolyte sheet deflections, and higher is the possibility for electrolyte and/or seal failure. Therefore, it is preferable for thin, relatively large size electrolyte sheets (with an area more than 250 cm², more 300 cm² and especially more then 400 cm²) to have the sealed area with the aspect ratio L:W that is larger than 1:1, preferably between 1.3:1 and 20:1, more preferably between 1.5:1 and 10, and even more preferably between 2:1 and 8:1. Thus, according to the exemplary embodiments of the present invention described below, the seal 60 has an elongated geometry, so that the length L of the electrolyte sheet enclosed within the seal is larger than its width W. The seal 60 may be made of soft glass which exhibits desired strain point in the range of 350-900° C., or glass-ceramic, ceramic, or metal (e.g., CuAg based seal), or ceramic-metal brazed seals glass. An example of the soft glass seal material is an alkali containing borosilicate glass seal with the following composition: (a) glass frit (on molar basis): Li₂O, 4.0%; CaO, 7.0%; SrO, 18.0%; Al₂O₃, 3.0%; B₂O₃, 10.0%; SiO₂, 58.0%; and (b) 8YSZ filler (on molar basis): Y₂O₃, 8.0%, ZrO₂, 92.0%. Several examples of glass-ceramic frit compositions (on molar basis) are provided below in Table 1.

TABLE 1

| | Sample No. | | | | |
|---|---|---|---|---|---|
| | (1) | (2) | (3) | (4) | (5) |
| SiO₂ | 40.4 | 39.2 | 42.8 | 38.8 | 37.4 |
| Al₂O₃ | | 2.9 | | | 7.4 |
| CaO | 25.2 | 24.5 | 29.9 | 21.7 | 23.3 |
| SrO | | | | | |
| BaO | 34.4 | 33.4 | 27.3 | 39.5 | 31.9 |
| MgO | | | | | |
| ZnO | | | | | |
| Base | (Ca_{.67}Ba_{.33})—SiO₃ | (Ca_{.67}Ba_{.33})—SiO₃ | (Ca_{.75}Ba_{.25})—SiO₃ | (Ca_{.60}Ba_{.40})—SiO₃ | (Ca_{.67}Ba_{.33})—SiO₃ |
| Cyclosilicate | | | | | |
| XRD | Walst s.s. | Walst s.s. | Walst s.s. | Walst s.s. | Walst. s.s. + m. |
| | | | | | glass |
| CTE 25-700 × ° C. | | 110.2 × 10⁻⁶ | | | 104.8 × 10⁻⁶ |
| ppm | | | | | |
| | Sample No. | | | | |
| | (6) | (7) | (8) | (10) | (11) |
| SiO₂ | 35.2 | 47.8 | 45.5 | 41.0 | 39.8 |
| Al₂O₃ | 4.8 | | 4.8 | 4.8 | 7.4 |
| CaO | 21.0 | 35.7 | 34.0 | 19.0 | 18.5 |
| SrO | | 16.5 | 15.7 | 35.2 | 34.3 |
| BaO | 38.0 | | | | |
| MgO | | | | | |
| ZnO | | | | | |
| Base | (Ca_{.50}Ba_{.50})—SiO₃ | (Ca_{.80}Sr_{.20})—SiO₃ | (Ca_{.80}Sr_{.20})—SiO₃ | (Ca_{.50}Sr_{.50})—SiO₃ | (Ca_{.50}Sr_{.50})—SiO₃ |
| Cyclosilicate | | | | | |
| XRD | Walst. s.s. | Cyclowoll | Cyclowoll s.s. + μ | μ s.s. + m. | Cyclowoll + m. |
| | | | s.s | glass | μ s.s. + m. |
| | | | | | glass |
| CTE 25-700 × ° C. | | | 102.2 × 10⁻⁶ | 100.2 × 10⁻⁶ | |
| ppm | | | | | |

| | Sample No. | | | | |
|---|---|---|---|---|---|
| | (12) | (13) | (14) | (15) | (16) |
| SiO₂ | 34.8 | 47.8 | 42.3 | 42.4 | 44.5 |
| Al₂O₃ | 4.8 | 4.8 | 7.1 | 3.8 | 3.8 |
| CaO | 10.9 | 27.2 | 31.6 | 29.3 | 32.3 |
| SrO | 20.0 | 12.6 | 14.6 | 7.9 | 12.7 |
| BaO | 29.6 | | | 16.5 | 6.6 |
| MgO | | 7.6 | | | |
| ZnO | | | 4.4 | | |
| Base | (Ca_{..33}Sr_{.33}—Ba_{.33})SiO₃ | (Ca_{.64}Sr_{.16}—Mg_{.20})SiO₃ | (Ca_{.80}Sr_{.20})—SiO₃ + ZnO | (Ca_{.73}Sr_{.10}—Ba_{.17})SiO₃ | (Ca_{.77}Sr_{.16}—Ba_{.07})SiO₃ |
| Cyclosilicate | | | | | |
| XRD | Walst + μ | Cyclowoll + | μ s.s. + hardy. + | Walst + | Cyclowoll + m. |
| | s.s. + glass | diop + m. aker | glass | cyclowoll + glass | Walst |
| CTE | 105.9 × 10⁻⁶ | 94.9 × 10⁻⁶ | 85.5 × 10⁻⁶ | 108.2 × 10⁻⁶ | 111.3 × 10⁻⁶ |
| 25-700 ° C. | | | | | |

Sample No.

| | (17) | (18) | (19) | (20) |
|---|---|---|---|---|
| SiO₂ | 52.4 | 50.7 | 47.9 | 46.5 |
| Al₂O₃ | 4.8 | 4.8 | 4.8 | 4.8 |
| CaO | 28.6 | 37.5 | 36.7 | 36.4 |
| SrO | | | | |
| BaO | | | | |
| MgO | 14.3 | 7.0 | 5.7 | 5.0 |
| ZnO | | | 5.0 | 7.4 |
| Base | | | | |
| Cyclosilicate | | | | |
| XRD | Diopside | Diopside + m. | Cyclo + Diop + Hard/ | Hardyston. + m. |
| | | cyclo- | Aker | diop, |
| | | Woll. + Aker | | cycl. |
| CTE 25-700 ° C. | | 98.8 × 10⁻⁶ | 102.5 × 10⁻⁶ | 97.3 × 10⁻⁶ |

Cyclowoll = cyclo-Wollastomite
Walst = Walstromite
Hardyston = hardystonit
Aker = åkermanite
μ s.s. = μ-(Ca,Sr)SiO₃
diop = diopside
m = minor

The height h (thickness) of the seal 60 is preferably between 100 μm and 4 mm and, the cross-sectional width w of the seal material is about 1 mm to 12 mm. Preferably h<w. More preferably 2h≦w.

Applicants also found that there is a minimum thickness h of the seal 60 necessary to accomplish the desired amount of sealing protection-and seal longevity. We have tested a 50 micrometers thin seal (i.e., seal height h=50 μm). The thinner seal (h<50 μm) may not be sufficient to protect the integrity of the device, thermal-mechanical stresses can cause delamination of the seal from the device and/or the frame. A seal that is too thick may crack during the heat cycling because its coefficient of fuel cell device 10. However, a 100 μm to 4 mm thick seal with a cross-sectional width w of 1 mm to 12 mm provides sufficient adhesion and mitigates (lessens) the effects of CTE mismatch during the heat cycles, thereby reducing the probability of the mechanical breakage. It is preferable that the seal height (thickness) be below 3 mm. It is more preferable that the thickness be between 1 mm and 2 mm and the cross-sectional width w of the seal 60 be between 2 mm and 10 mm.

### Exemplary Embodiments

The invention will be further clarified by the following examples.

### EXAMPLE 1

A solid oxide fuel cell device 10 shown in FIG. 2A is similar to that shown in FIG. 1 but includes a rectangular electrolyte sheet 20 and substantially rectangular seal geometry. More specifically, the fuel cell device 10 of FIG. 2 includes: a rectangular ytria-stabilised zirconia (YSZ) electrolyte sheet 20; with a plurality of electrodes 30 situated on the electrolyte sheet 20, including at least one cathode 32 and one anode 34 (not shown in FIG. 2A, but see, for example, FIG. 1). The electrolyte sheet 20 may be also based on following compositions: Bismuth (Bi₂O₃)—, Ceria (CeO₂)— and tantala (Ta₂O₅)— and the LSGM—(Lanthanum Strontium Gallium Magnesiun Oxide)A rectangular metal frame 50 supports the rectangular electrolyte sheet 20 and electrodes 30 attached thereto. In this embodiment the solid oxide fuel cell device 10 comprises the electrolyte sheet 20 that supports a plurality of cathode 32-anode 34 pairs and has a plurality of via holes filled with via interconnects 22. In this example, the frame 50 does not provide an electrical function. FIG. 2B illustrates schematically a partial electrolyte/seal/frame cross-section of the fuel cell device 10 shown in FIG. 2A.

As stated above, in this embodiment, this seal 60 is a substantially rectangular, with rounded corners, for further stress reduction. It is preferable that the radius of the corners (or seal boundary radius) be at least 5 mm, more preferably at least 12 mm. For example a boundary radius of 15 mm, 20 mm, 25 mm, 30 mm, 40 mm, 50 mm, 55 mm, 60 mm, 65 mm, 70 mm, 75 mm, or 80 mm may also be utilized. Applicants found that as boundary radius r increases (especially above 5 mm, for electrolyte sheets having a sealed area width W>10 cm) the performance/reliability of the electrolyte sheet 20 is improved. In this embodiment the aspect ratio of L:W ratio of the sealed electrolyte area is about 2.5:1, but other aspect ratios, for example, 1.2:1; 1.3:1; 1.4:1; 1.5:1; 2:1; 2.5:1; 3:1, 3.5:1; 4:1: 4.5:1; 5:1, 7:1, 10:1, 12:1, 15:1, 18:1 and 20:1 may also be utilized. In this embodiment the corners of the electrolyte sheet 20 overlap the seal 60 creating an overhang area (see FIG. 2B, distance O), reducing the amplitude of wrinkles (caused by processing of electrolyte and/or subsequent thermal-mechanical treatment/cycling) in the electrolyte sheet corner areas, and thus further reducing the possibility of the SOFC device failure. It is preferable that the maximum distance O within the overhang is at least 2 mm, preferably at least 5 mm. It is preferable that the frame 50 and the electrolyte sheet 20 have similar coefficients of thermal expansion (CTE). Thus, because zirconia based electrolytes have a CTE of 11.4×10⁻⁶/° C., it is preferable that the frame 50 has a CTE in the range of 10×10⁻⁶/° C. to 13×10⁻⁶/° C. It is more preferable that the CTE of the frame 50 be in the 11×10⁻⁶/° C. to 12×10⁻⁶/° C. range and most preferable that it is in 11.2×10⁻⁶/° C. to 11.7×10⁻⁶/° C. range. In this example the metal frame 50 is manufactured from the stainless steel 446 which has a CTE 11.6.×10⁻⁶/° C. Table 2, below, provides CTE for some of these materials.

TABLE 2

| Material | CTE |
|---|---|
| ZrO₂ electrolyte | 11.4 × 10⁻⁶/° C. |
| Fe—20% Cr 446 stainless steel | 11.6 × 10⁻⁶/° C. |
| Fe—20% Cr—5% Al alloys | 14.5 × 10⁻⁶/° C. |

When the stainless steel frame 50 is subjected to temperatures above 625° C., the interface between the electrolyte sheet 20 and the seal 60 experiences thermo-mechanical stress. It is preferable that the electrolyte sheet be thin, for example, thinner than 45 μm, and preferably between 3 μm and 30 μm. When the thin flexible electrolyte deflects, thermal-mechanical stresses at the electrolyte sheet mounting interface increase. The amount of defection and stress increases as the electrolyte area increases. However, when the aspect ratio (length L to width W) at the seal perimeter increases (wherein L/W>1), the amount of electrolyte sheet deflection is minimized. Correspondingly, in response to differential gas pressure, there is less stress at the mounting interface (at the seal perimeter) of the SOFC device having L/W>1, as compared to a fuel cell device with L/W of 1. Because the seal 60 has rounded corners, stress is distributed relatively evenly along the seal edges, minimizing failure of the seal 60 and/or of the electrolyte sheet 20. Therefore the relatively long length L of the sealed area of the electrolyte sheet 20 with respect to its width W, and the rounded seal corners minimize thermal-mechanical stress and reduce the possibility of failure of the seals and/or electrolyte sheets at or adjacent to seal perimeter, thus increasing longevity and reliability of SOFC devices.

In addition, FIG. 2B illustrates a seal 60 with width w larger than its height h (h<w). A shorter, wider seal is less fracture prone and has a larger bonding area, which results in less stress, thus reducing the likelihood of seal fracture and/or electrolyte fracture in the area adjacent to the seal. Therefore, it is preferable that 1.5h<w<10h, and even more preferable 2h<w<8h. In this exemplary embodiment, as shown in FIG. 2B, w≅3h.

### EXAMPLE 2

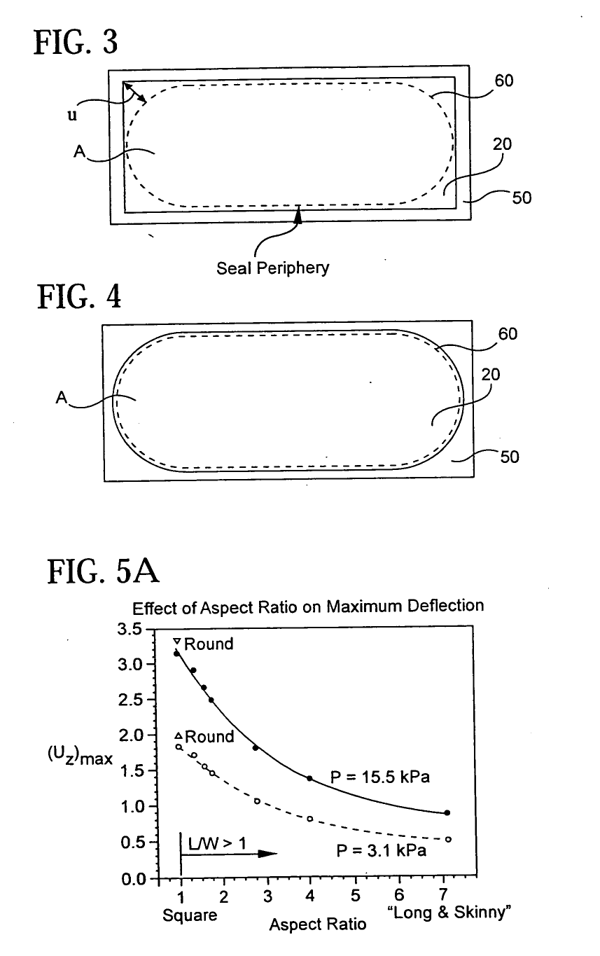

Another embodiment of the present invention is illustrated schematically in FIG. 3. The fuel cell device shown in FIG. 3 also utilizes a rectangular electrolyte sheet 20 mounted on a rectangular frame 50. The periphery geometry of the seal 60 is however different. The seal 60 of FIG. 3 has a “race track” geometry—i.e., it includes two relatively straight sides that are parallel to one another and two arcuate (e.g., semicircular) sides. For example, the boundary radius r of the arcuate portion of the seal 60 is between 5 cm and 20 cm (50 mm≦r≦200 mm). In this exemplary embodiment the seal boundary radius is r=8 cm. This seal geometry tends to be better than that shown in FIG. 2, because it allows for a better (more even) distribution of stress along the periphery of the seal 60. Because the seal 60 has arcuate geometry (e.g., substantially rounded areas) and the electrolyte sheet corners substantially overlap the rounded seal area, stress is distributed evenly along the seal edges and the amplitude of electrolyte sheet's wrinkles produced by thermal cycling is further reduced. It is also noted-that the overlap O between the seal periphery and the corner of the electrolyte sheet 60 is larger than that of the embodiment of example 1, thus further reducing wrinkle amplitude in electrolyte corner areas.

Therefore the relatively long length L of the sealed area of the electrolyte sheet 20, with respect to the width W of the sealed area, along with the rounded corners of the seal (and electrolyte sheet overhang O at the corners) contribute to minimization of thermal-mechanical stress and reduction of failure probability of the seals and/or electrolyte sheets at or adjacent to seal perimeter, thus increasing longevity and reliability of SOFC devices. In this exemplary embodiment, as in the previous embodiment, the seal width w is larger than the seal height h. Preferable seal geometries satisfy the h/w ratio so that ⅛<h/w≦¾. For example, h/w may be 0.125, 0.15, 0.2, 0.25, 0.3, 0.35, 0.4, 0.45, 0.5, 0.6, or 0.66.

### EXAMPLE 3

Another embodiment of the present invention is illustrated schematically in FIG. 4. The fuel cell device of FIG. 4 is similar to that shown in FIG. 3. The periphery geometry of the seal 60 is identical to that shown in FIG. 3. However, in this embodiment, both the electrolyte sheet 20 and seal 60 substantially overlap and both include two relatively straight sides that a parallel to one another, and two arcuate (e.g., semicircular) sides. Furthermore, because both the electrolyte sheet 20 and the seal 60 have almost identical, arcuate geometries, the number of electrolyte sheet wrinkles in response to thermal-mechanical loading of the electrolyte sheet is further reduced. Thus, this seal/electrolyte sheet geometry has an advantage of having fewer wrinkles resulting from the thermal cycling of the electrolyte sheet.

### Analysis

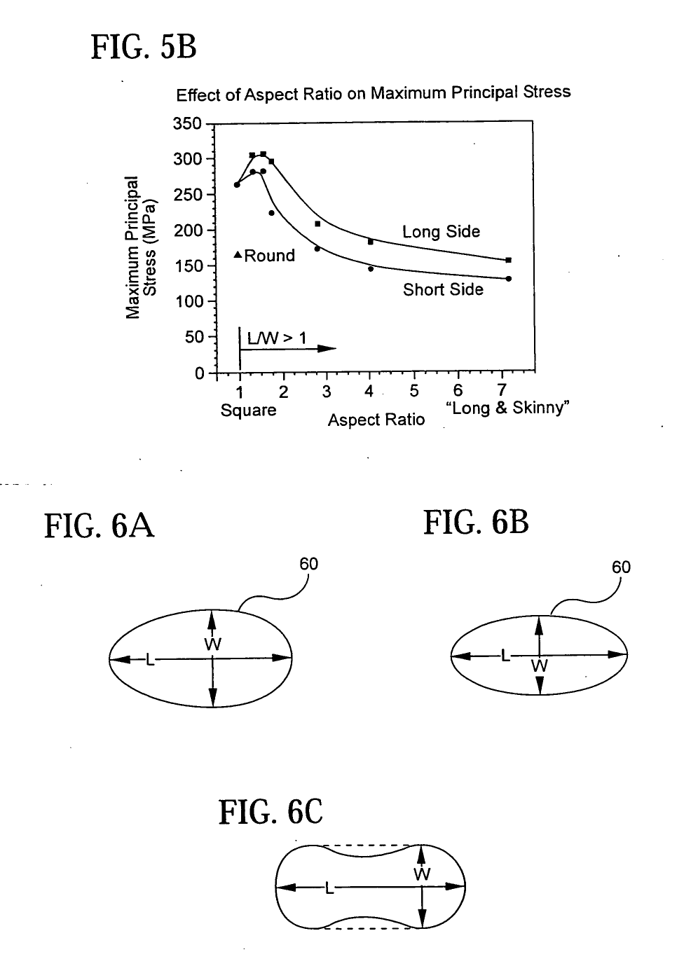

FIGS. 5A is a plot of maximum electrolyte sheet deflection for the rectangular electrolyte sheets (corresponding to the devices shown in FIG. 2) of the same size area, but with different aspect ratios, as well as for the round (circular) electrolyte sheet/seal combination (which also has aspect ratio of 1:1). Two sets of models were utilized. The top curve corresponds to the differential gas pressure P (fuel and oxidant), where P is 15.5 kPa. The lower curve corresponds to the differential gas pressure P where P is 3.1 kPa. Both curves show a clear downward trend with the increasing aspect ratio. Thus, FIG. 5A illustrates that the deflection of the rectangular electrolyte sheet becomes smaller as the L/W ratio (aspect ratio) is increased. It also illustrates that the electrolyte sheet with a circular cross-section experiences a slightly larger deflection than a square electrolyte sheet (i.e., the rectangular sheet with the aspect ratio of 1.)

FIGS. 5B is a plot of maximum principal stress (MPa) of the electrolyte sheet 20 along the sides of the rectangular electrolyte sheets with same area, but with different aspect ratios, as well as MPa for the round (circular) electrolyte sheet. The graph corresponds to the differential gas pressure P of 3.1 kPa. FIG. 5B illustrates that maximum principal stress (MPa) of the rectangular electrolyte sheet becomes lower as the L/W ratio (aspect ratio) is increased. It also illustrates that the electrolyte sheet with a circular cross-section experiences much less stress than a square electrolyte sheet.

Thus, FIGS. 5A and 5B illustrate that implementing an elongated seal geometry with aspect ratios L/W greater than 1, and/or elongated electrolyte sheets reduces both deflection and stress at the seal/mounting interface for given set of operating variables and material selection. Both trends of decreasing deflection and decreased maximum stress at the seal interface are beneficial for any operating temperature ranges (25° C. to 900° C.) of the fuel cell devices. FIGS. 5A and 5B also illustrate that round seal/mounting geometry is effective in lowering stresses, although it is at the expense of increasing deflection of the electrolyte sheet 20.

The combinational beneficial effect of rounded geometry and higher aspect ratio structures may be exploited by combining the geometrical structures of round and a rectangular to provide a rounded elongated seal/electrolyte sheet mounting geometry. It is noticed that continuous arcs are good at equally distributing deflection and stress along the seal and/or mounting edge of the electrolyte sheet 20. Implementing the use of arcuous seal/mounting edges with larger aspect ratio seal/mounting edges results in continuous seal/mounting lines similar to those depicted in FIGS. 6A-C. It is important to note that the continuous seal/mounting edges may also include those forms which are not constant in radius (such as ellipse, parabolic, etc.) pursuant to specific deflection and stress mitigation requirements. Examples of oval, elliptical or other elongated-geometries for the sealed area of the electrolyte sheet or seal 60 are shown in FIGS. 6A-6C.

In typical planar SOFC stacks (i.e., multiple device stack), fuel cell device spacing is primarily dictated by material thickness of a device, electrical interconnects and gas routing structures (e.g., bipolar plates). SOFC stacks such comprised of perimeter mounted and/or sealed cells and/or devices should also take into account deformation of the cells/devices as part of the device spacing, such that two cells/devices/ electrodes from adjacent devices, and/or electrolyte sheets do not physically contact. This requirement prevents gas mal-distribution and electrical shorting issues. Minimum cell and/or device spacing is thus determined by maximum cell/device deflection under loading conditions.

As just described, spacing of cells/devices in a SOFC stack (1×n array) is in part defined by maximum deflection of said cells/devices under loading conditions. This spacing also determines (in part) the overall volumetric power density (Pv) of a stack. The device packing density is defined as

$$DPD = \frac{1}{2 {U}_{max}}$$

(number of devices/cm), where Uₘₐₓ=maximum device deflection (cm) and

$${U}_{max} = a + b exp [ \frac{- ( L / W ) - 1}{2.32} ]$$

where a and b are constants depending on the differential gas pressure (between the fuel and oxidant), (L/W) is the ratio of length to width of device or the sealed area of the electrolyte sheet (referred to as the Aspect Ratio herein).

A simple expression of stack volumetric power density as a function of device spacing is as follows

Pᵥ=Pₐ×DPD (1)

### Where: Pᵥ=Volumetric Power Density (W/cm³)

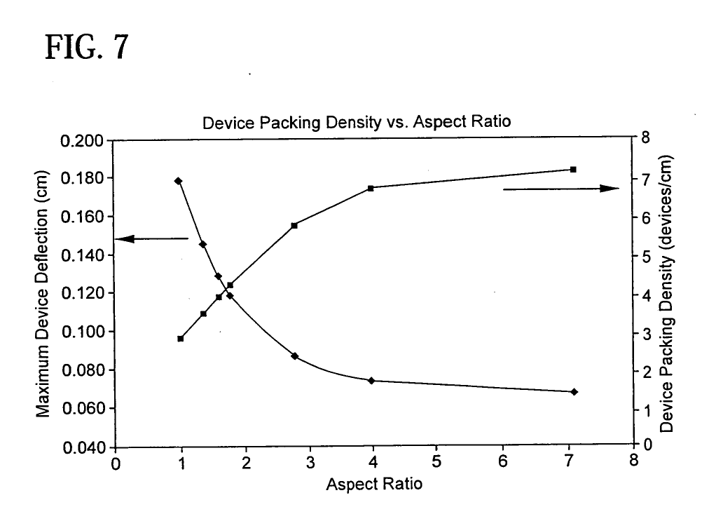

Pₐ=Active Area Power Density (W/cm²), the power generated by the active area (area of the electrodes) of the fuel cell device.
   FIG. 7 illustrates the relationship between Umax, DPD and the aspect ratio. More specifically FIG. 7 illustrates that maximum deflection decreases and the DPD increases with increasing aspect ratios. That is, DPD (and, therefore, volumetric power density Pv) increases with increasing aspect ratio. With decreasing device deflection, we are able to reduce the device spacing in the fuel cell stack, putting more devices within a given space. Preferably the electrolyte sheet 20 has a thickness of less than 45 μm and more preferably less than 30 μm, and the device thickness (electrolyte plus electrodes) is less than 150 μm, and more preferably less than 100 μm. Preferably, the sealed area of the device 10 is larger than 250 cm². In this example it is 300 cm². Preferably, the maximum deflection of the device 10 (and/ or of the electrolyte sheet 20) electrolyte sheet 20 is less than 0.18 cm, more preferably less than 0.15 cm and even more preferably, less than 0.12 cm. This results in a solid oxide fuel cell stack comprising a plurality of fuel sell devices, wherein electrolyte to electrolyte separation between devices is between 1 mm and 1 cm, and more preferably between 1 mm and 3 mm. Preferably, the aspect ratio L/W of the sealed area of the electrolyte sheet is greater than 2, more preferably >3 and even more preferably >3.5. Preferably, the DPD of the fuel cell stack is more than 3 devices/cm, more preferably at between 3.5 and 10 devices/cm, and most preferably greater than 5 devices/cm.

For example, given an active area power density of 0.15 W/cm² and an aspect ratio of 1.1 corresponding to a Umax of 0.178 cm, the maximum achievable volumetric power density, Pv, is 0.42 W/cm³. If the aspect ratio is changed to about 5, which corresponds to a Umax of 0.07 cm, the maximum achievable volumetric density, Pv, is 1.07 W/cm³. Similarly, given an active area power density of 0.3 W/cm² and an aspect ratio of 1.1 corresponding to a Umax of 0.178 cm, the maximum achievable volumetric power density, Pv, is 0.84 W/cm³. If the aspect ratio is changed to about 5, which corresponds to a Umax of 0.07 cm, the maximum achievable volumetric density, Pv, is 2.14 W/cm³. Given an active area power density of 0.5 W/cm² and aspect ratios of 1.1 and 5, Pv is 1.40 W/cm³ and 3.57 W/cm³, respectively. When the active area power density, Pa, is 1 W/cm², Pv is 2.81 W/cm³ and 7.14 W/cm³, respectively, corresponding to aspect ratios of 1.1 and 5. Thus, exemplary Pv values for these embodiments are 0.5 W/cm³, 0.75 W/cm³, 1 W/cm³, 2 W/cm³, 3 W/cm³, 4 W/cm³, 5 W/cm³, 6 W/cm³, and 7 W/cm³. It is preferable that Pv be greater than 0.5 W/cm³, more preferable that Pv be greater than 0.75 W/cm³, and even more preferable that Pv be greater than 1 W/cm³. It is even more preferable that Pv be greater than 5 W/cm³, and most preferable that Pv be greater than 7 W/cm³.

It will be apparent to those skilled in the art that various modifications and variations can be made to the present invention without departing from the spirit and scope of the present invention. Thus it is intended that the present invention cover the modifications and variations of this invention provided they come within the scope of the appended claims and their equivalents.

What is claimed is:

1. A solid oxide fuel cell device comprising:
(a) electrolyte sheet;
(b) at least one electrode pair sandwiching the electrolyte;
wherein said electrolyte sheet has a sealed area that is elongated, has arcuate geometry and has a length to width aspect ratio of more than 1.

2. The solid oxide device according to claim 1, wherein the electrolyte sheet has an area of at least 250 cm² and a length to width ratio of at least 1.3 to 1.

3. The solid oxide device according to claim 1, wherein: said solid oxide electrolyte sheet is a thin flexible electrolyte sheet with a thickness not more than 100 μm, said electrolyte sheet being based on a composition selected from zirconia, bismuth (Bi₂O₃), ceria (CeO₂), tantala (Ta₂O₅), and the LSGM—(Lanthanum Strontium Gallium Magnesiun Oxide, said electrolyte sheet supports least 10 electrode cathode/anode pairs; said device further comprising a frame supporting said electrolyte sheet; and a seal adjacent to the perimeter of said electrolyte sheet and situated between said electrolyte sheet and said frame, said seal sealing said electrolyte sheet to said frame.

4. The solid oxide device according to claim 3, wherein the sealed area of the electrolyte sheet is least 250 cm² and has length to width ratio of at least 1.5 to 1.

5. The solid oxide device according to claim 4, wherein the sealed area of the electrolyte sheet has an area of at least 300 cm² and a length to width ratio between 2 to 1 and 20 to 1.

6. The solid oxide device according to claim 4, wherein said electrolyte sheet is less than 45 μm thick.

7. The solid oxide device according to claim 4, wherein the thickness of said electrolyte sheet is 3 μm to 30 μm.

8. The solid oxide fuel cell device of claim 1, wherein seal's thickness h is between 100 μm and 4 mm.

9. The solid oxide fuel cell device of claim 1, wherein seal's cross-sectional width w is 1 mm to 12 mm.

10. The solid oxide fuel cell device of claim 1, wherein said seal comprises one of the following: soft glass, glass-ceramic, metal, ceramic-metal braze.

11. The solid oxide fuel cell device of claim 1, wherein said metal frame has a coefficient of thermal expansion CTE of 1×10⁻⁶/° C. to 13×10⁻⁶/° C.

12. The solid oxide fuel cell device of claim 11, wherein said metal frame has a CTE of 11×10⁻⁶/° C. to 12×10⁻⁶/° C.

13. The solid oxide fuel cell stack including a fuel cell device of claim 1, wherein device packing density DPD is more than 3 devices/cm.

14. The solid oxide fuel cell device of claim 1, wherein said seal has a perimeter with radiused edges and the radius is greater than 5 mm.

15. The solid oxide fuel cell device of claim 1, wherein said seal has a perimeter with radiused edges and the radius is greater than 5 cm.

16. The solid oxide fuel cell device of claim 1, wherein said seal has a height/thickness h and width w, so that h<w.

17. The solid oxide fuel cell device of claim 16, wherein said seal has a height/thickness to width ratio h/w, so that 1/8≦h/w≦3/4.

18. The solid oxide fuel cell device of claim 1, wherein said device further comprising a frame supporting said electrolyte sheet; and a seal adjacent to the perimeter of said electrolyte sheet and situated between said electrolyte sheet and said frame, said seal sealing said electrolyte sheet to said frame, and said electrolyte sheet overhanging said seal in at least one area.

19. The solid oxide fuel cell device of claim 18, wherein said overhang is at least 5 mm.

20. The solid oxide fuel cell device of claim 1, wherein said device has a maximum deflection of 0.18 mm

21. A solid oxide fuel cell stack comprising a plurality of fuel cell devices of claim 1, wherein electrolyte to electrolyte separation is between 1 mm and 1 cm.

22. A solid oxide fuel cell stack comprising a plurality of fuel cell devices of claim 1, wherein electrolyte to electrolyte separation is at between 1 mm and 3 mm.

23. A solid oxide fuel cell stack comprising a plurality of fuel cell devices of claim 1, wherein volumetric power density Pv is greater than 0.42 W/cm³.

24. A solid oxide fuel cell stack comprising a plurality of fuel cell devices, each of said fuel cell devices including an electrolyte sheet and at least one electrode pair sandwiching the electrolyte sheet; wherein electrolyte to electrolyte separation is at between 1 mm and 3 mm.

25. A solid oxide fuel cell stack comprising a plurality of fuel cell devices, each of said fuel cell devices including an electrolyte sheet and at least one electrode pair sandwiching the electrolyte sheet; wherein device packing density DPD is greater than 3 devices/cm.
